(19) United States
(12) Patent Application Publication
(10) Pub. No.: US 2017/0297485 A1
(43) Pub. Date: Oct. 19, 2017

(54) Car Seat Alarm System

(71) Applicants: George Biesaga, Fountain Inn, SC (US); Elzbieta Biesaga, Fountain Inn, SC (US)

(72) Inventors: George Biesaga, Fountain Inn, SC (US); Elzbieta Biesaga, Fountain Inn, SC (US)

(21) Appl. No.: 15/418,597

(22) Filed: Jan. 27, 2017

Related U.S. Application Data
(60) Provisional application No. 62/287,673, filed on Jan. 27, 2016.

(51) Int. Cl. B60Q 5/00; B60N 2/28; B60Q 9/00; G08B 21/02

(52) U.S. Cl. CPC B60Q 5/005; G08B 21/0202; B60N 2/2812; B60Q 9/00

(57) ABSTRACT

A car seat alarm system for alerting a parent or caretaker to retrieve the infant child prior to exiting a vehicle is provided. The vehicle has an openable door mounted within a door frame. The car seat alarm system comprises a child car seat having a harness and a fastener positioned on the harness. The fastener is closable to secure the harness around the infant child and openable to unsecure the harness from around the infant child. A transmitting system is mounted on the child car seat. A receiving system is associated with the door and the door frame and directly interfaces with the transmitting system. Upon opening the door from within the door frame, with the fastener dosed to secure the harness around the infant child, the transmitting system provides an alert. The alert reminds the parent or caretaker to retrieve the infant child prior to exiting.

### CLAIM OF PRIORITY

This patent application claims priority under 35 USC 119 (e) (1) from U.S. Provisional Patent Application Ser. No. 62/287,673 filed Jan. 27, 2016, of common inventorship herewith entitled, “Child's Car Seat Alarm,” which is incorporated herein by reference as though the same were set forth in its entirety.

### FIELD OF THE INVENTION

The present invention pertains to the field of infant car seats, and more specifically to the field of alert alarms for car seats.

### BACKGROUND OF THE INVENTION

On hectic and busy days, it is very easy for adults to experience momentary confusion and lapses in judgment. Juggling daunting demands of career and family, parents are particularly susceptible to brain lapses despite their best intentions and diligence. Rushing from work to collect children from school or day care, a parent may have to complete a plethora of other errands before finally reaching home such as making a bank deposit or picking up a few items from the market for dinner. When in a hurry, a parent may consider it safe to cave a child in the car quickly dashing into an establishment or a parent may be so harried they leave a child behind without realizing they have done so. Leaving a child alone in a car even for a short period of time can lead to tragic circumstances, especially on hot days. All it takes is a few minutes for a temperature inside a car to rise to dangerous levels, even with the windows cracked. On a mild day of seventy three degrees outside, a vehicle can heat up to one hundred degrees in approximately ten minutes and to one hundred twenty degrees in approximately thirty minutes. As outdoor temperature rises. so does heat buildup in a vehicle. At ninety degrees outside, an interior of a vehicle can heat up to one hundred sixty degrees within several minutes. A child's developing respiratory system makes them particularly vulnerable to heat exhaustion. As heat rises, their body temperatures rise. An infant in a broken down, car in one hundred ten degree heat can get in trouble quickly. Infants tend to heat up very quickly, rapidly approaching the temperature of their environment. Sadly, dozens of children die each year as a result of having been left alone in motor vehicles.

The prior art has put forth several designs for alert alarms for car seats. Among these are:

U.S. Pat. No. 7,714,737 to James Morningstar describes a warning system for notifying another person when a child is left in a child safety seat. The system recognizes a child in a child safety seat by either a pressure pad or a secured child seat lap belt. The system is activated by the release of the driver's seat belt. If a child remains in the child seat when the driver's seat belt is disengaged, the system alarms notifying the driver the child still is in their seat. The alarm includes a calm audio output such as a lullaby, a song, or a story The system can be integrated into OEM features to provide an alert escalation process using a local alert, a vehicle alert, a wireless alert and ultimately a 911 alert

U.S. Pat. No. 7,378,979 to Victor H. Rams, Jr., describes a system for detecting the presence of a child in a car when the driver exits the vehicle. A sensor is connected to the seat belt of the baby's car seat or to the rear at belts. Once the seat belts inserted into the belt buckle, an alarm circuit is activated. When the driver enters the vehicle and sits down, the system detects the presence of the driver and deactivates the alarm circuit. When the driver exits, the alarm circuit is then reactivated. The system includes a delay timer that gives the driver time to enter and exit the vehicle without setting off the alarm circuit. When the alarm circuit is activated, a timer for the time lay begins. At the end of the time del if the driver has not disabled the alarm circuit by reentering the vehicle or taking the child out of the vehicle, the alarm circuit sets off warning signals and remains energized until disabled.

U.S. Pat. No. 6,535,137 to Janet Lee Ryan describes a child seat alarm including a car seat portion adapted for being positioned within a motor vehicle. The car seat portion includes child engagement straps. The child engagement straps include a male buckle and a corresponding female receptacle. The male buckle is lockably received within the female receptacle in a locked orientation. An alarm is disposed within the car seat portion. The alarm includes a pair of speakers for broadcasting an audible alarm. The alarm is in an activated orientation when the male buckle is lockably received within the female receptacle. The alarm is in a deactivated orientation when the male buckle is removed from the female receptacle. The alarm is in communication with an electrical system of the vehicle whereby a shutdown of the motor vehicle's engine or an opening of a driver s door will sound the alarm when the alarm is in the activated orientation.

None of these prior art references describe the present invention.

### SUMMARY OF THE INVENTION

It is an object of the present invention to provide a car seat alarm system used in automobiles to emit an audible alarm that reminds a parent or caretaker to retrieve their infant child prior to exiting a vehicle.

The present invention is a car seat alarm system for alerting a parent or caretaker to retrieve their infant child prior to exiting a vehicle. The vehicle has an openable door mounted within a door frame. The car seat alarm system comprises a child car seat having a harness and a fastener positioned on the harness. The fastener is closable to secure the harness around the infant child and openable to unsecure the harness from around the infant child. A transmitting system is mounted on the child car seat. A receiving system is associated with the door and the door frame and directly interfaces with the transmitting system. Upon opening the door from within the door frame, with the fastener closed to secure the harness around the infant child, the transmitting system provides an alert. The alert reminds the parent or caretakers to retrieve the infant child prior to exiting the vehicle.

In addition, the present invention includes a method for alerting a parent or caretaker to retrieve their infant child prior to exiting a vehicle. The vehicle has an openable door mounted within a door frame. The method comprises providing a child car seat having a harness, positioning a fastener on the harness, closing the fastener secure the harness around the infant child, mounting a transmitting system on the child car seat, associating a receiving system with the door and the door frame, directly interfacing the receiving system with the transmitting system, opening the door from within the door frame, providing an alert reminding the parent or caretaker to retrieve the infant child prior to exiting the vehicle, opening the fastener to unsecure the harness from around the infant child, and removing the child from the child car seat and the vehicle.

The present invention further includes a car seat alarm system for alerting a parent or caretaker to retrieve their infant child prior to exiting a vehicle. The vehicle has an openable door mounted within a door frame. The car seat alarm system comprises a child car seat having a harness and a fastener positioned on the harness. The fastener is closable to secure the harness around the infant child and openable to unsecure the harness from around the infant child. A base alarm is mounted on the child car seat with the base alarm automatically engaged and armed when the fastener is closed to secure the child with the child car seat. A door contact system is associated with the door and the door frame and directly interfaces with the base alarm. The door contact system has a door mount sensor component mounted to the operable door and a door frame sensor component mounted to the vehicle door frame with the door mount sensor component and the door frame sensor component in magnetic contact with each other when the door is dosed within the door frame. Upon opening the door from within the door frame and breaking the magnetic contact between the door mount sensor component and the door frame sensor component, with the fastener closed to secure the harness around the infant child, the transmitting system provides an alert. The alert reminds the parent or caretaker to retrieve the infant child prior to exiting the vehicle.

### BRIEF DESCRIPTION OF THE DRAWINGS

FIG. 1 is a perspective view illustrating a car seat alarm system, constructed in accordance with the present invention, showing a car seat which an alarm incorporated into a belt buckle fastener that contains a wireless sensor locking clip with the alarm and when a driver's car door is opened, the alarm sounds unless the belt buckle has been detached prior to opening the door.

FIG. 2 is a perspective view illustrating the car seat alarm system, constructed in accordance with the present invention, showing a driver door sensor with a door frame sensor component, a door mount sensor component, and contact points.

FIG. 3 is an elevational side view illustrating the door frame of the vehicle for use with the car seat alarm system, constructed in accordance with the present invention with the door frame sensor component mounted thereon.

FIG. 4 is an elevational side view illustrating the door receivable within the door frame of the vehicle for use with the car seat alarm system, constructed in accordance with the present invention, with the door mount sensor component mounted thereon.

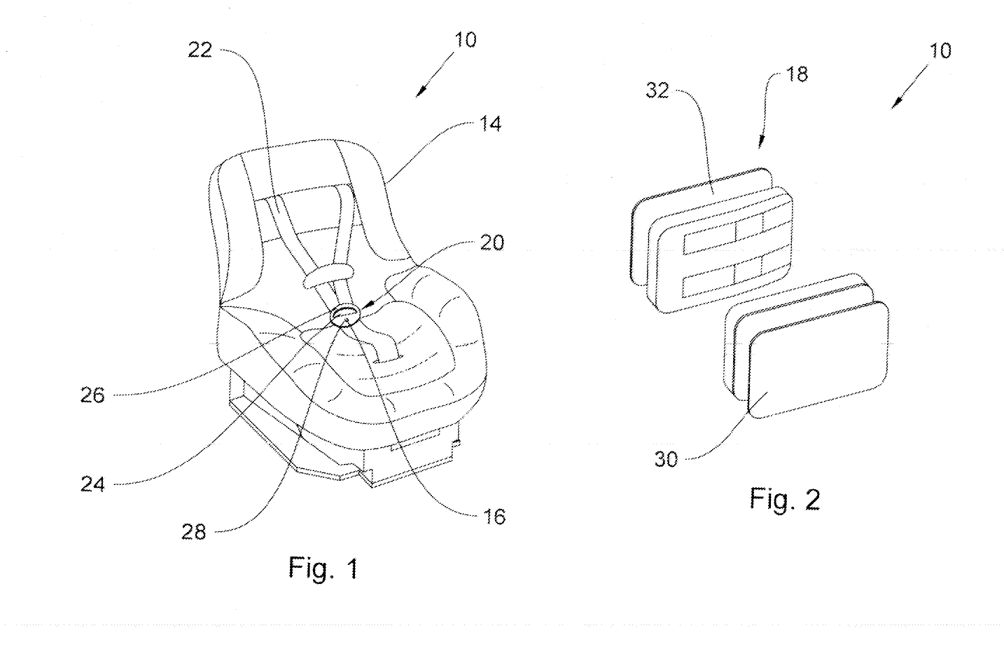

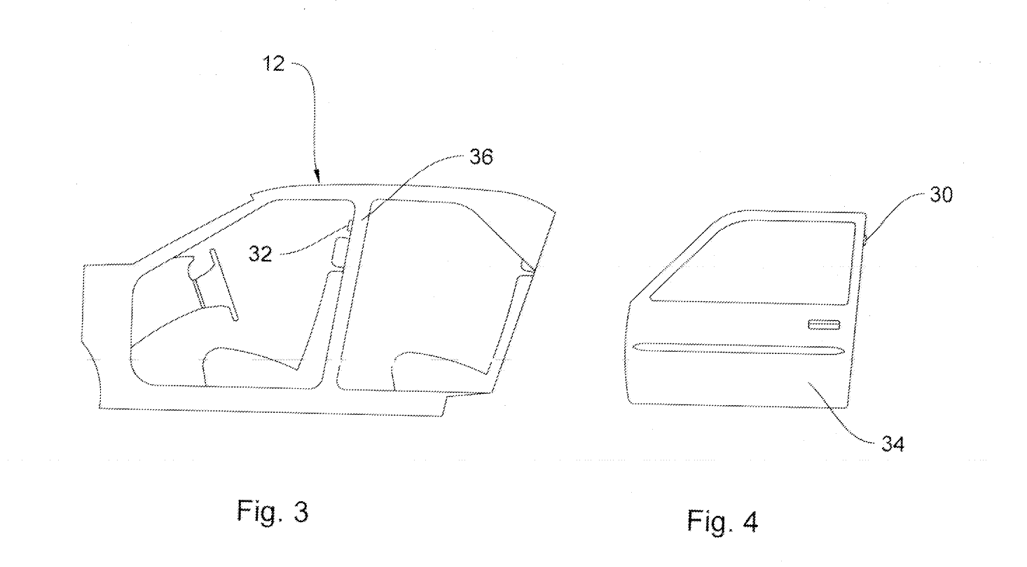

### DETAILED DESCRIPTION OF THE INVENTION

The present invention, hereinafter referred to as a Car Seat Alarm System, indicated generally at 10, is an alarm system used automobiles 12 to emit an audible alarm that reminds a parent or caretaker to retrieve their infant child from a child car seat 14 prior to exiting a vehicle 12. The Car Seat Alarm System provides parents and caregivers with an audible alert to prevent accidental tragedies that result when a child is left unattended in the child car seat 14 in a vehicle 12.

The Car Seat Alarm System 10 of the present invention is comprised of a transmitting system 16 and receiving system 18 that alerts the motorist to the presence of their child within the child car seat 14 within the vehicle 12 when they turn off the ignition and begin to exit the vehicle 12. In the case of an aftermarket version, the transmitting system 16 of the Car Seat Alarm System 10 is comprised of a specially configured base alarm 20 to be installed on the base or rear of the child's car seat 14. The base alarm 20 contains a corresponding sensor and transmitter mechanism 24 and is installed on the safety sears harness belting 22.

Preferably square shape, the base alarm 20 of the transmitting system 16 of the Car Seat Alarm System 10 of the present invention measures approximately four (4″) inches in length, approximately four (4″) inches in width, and approximately one half (½″) inch to one and one half (1½″) inches in depth. It should be noted that while the base alarm 20 has been described as being square shaped and having certain preferred dimensions, it is within the scope of the present invention for the base alarm 20 to be any desired shape including but not limited to round, oval, rectangular, triangular, etc. and to have any desired dimensions.

The base alarm 20 of the transmitting system 16 of the Car Seat Alarm System 10 of the present invention is releasably or permanently secured to the existing child safety seat 14. Preferably, the base alarm 20 is secured to the child safety seat 14 by means of corresponding look and loop fasteners although securing the base alarm 20 to the child safety seat 14 by other means is within the scope of the present invention.

In addition, the base alarm 20 of the Car Seat Alarm System 10 includes a sensor and transmitter mechanism communicating with the base alarm 20. The sensor and transmitter mechanism 24 is preferably sized appropriately to accommodate a tongue and groove buckle fastener 26 or locking clip that is utilized to restrain the child within the child safety seat 14. The sensor and transmitter mechanism 24 is automatically engaged and armed when the belt buckle 26 is inserted into its grooved connector. The sensor and transmitter mechanism 26 contains a simple adapter cord that is connected to any vehicle outlet port to provide necessary and required power or can be battery operated. A simple press button activation switch 28 located on the base alarm 20 activates and deactivates the base alarm 20 of the Car Seat Alarm System 10 following installation.

The receiving system 18 of the Car Seat Alarm System 10 of the present invention, which directly interfaces with the base alarm 20 of the transmitting item 16 mounted to the child's safety seat 14, includes a door contact system in electronic, wireless communication with the transmitting system 16. The door contact system includes a door mount sensor component 30 and a door frame sensor component 32. The door mount sensor component 30 is preferably mounted to an interior portion of the driver's side door 34 of a vehicle 12. The door frame sensor component 32 is preferably mounted to a vehicle door frame 36 or interior door panel. The receiving system 18 operates on the principal of a reed switch. A reed switch consists of a set of electrical connectors placed slightly apart. When a magnetic field is placed parallel to the electrical connectors, it pulls the electrical connectors together, closing the circuit. Typically, sensors have one reed switch and one magnet creating a closed circuit. If someone opens an armed door or window, the magnets pulled away from the switch, which breaks the circuit and triggers an event, i.e., the activation of an audible and/or visual alarm. In the present invention, the door mount sensor component 30 can include either the reed switch or the magnet while the door frame sensor component 32 will include the other, i.e., the magnet or the reed switch. When the door mount sensor component 30 is separated from the door frame sensor component 32, i.e. by opening the door 34, an alarm will sound or be displayed. The display of the alarm can be in the form of flashing lights on the vehicle 12 or a text message alert on a cellular telephone.

The receiving system 18 of the Car Seat Alarm System 10 of the present invention contains a speaker and integrated alarm, in either the door mount sensor component 30, the door frame sensor component 32, or both, which alerts a caregiver their child is in the vehicle prior to the motorist exiting their car. Each component of the receiving system 18 can be similar in dimensions to the transmitting component and is attached to the vehicle door frame 36 and the interior door panel 34. The receiving system 18 preferably utilizes a battery source such as a micro alkaline or silver oxide cell batteries.

As stated, when a driver prepares to exit the vehicle 12, the Car Seat Alarm System 10 of the present invention is triggered automatically when the driver turns off the vehicle ignition or opens the driver side door 34. Emitted from the companion receiving system 18, an alert alarm automatically sounds, thus alerting the driver or parent that the child still is secured within their car seat 14. The alert alarm continues to sound until the parent or caregiver has released the child's seat belt and harness 22 and has removed the child from their safety seat 14. The factory installed version Car Seat Alarm System 10 has the same basic machinations but is fully integrated into the vehicle 12 and the vehicle's computer system. The base alarm 20 and transmitting system 16 are installable to an existing child safety seat 14 or are pre integrated in newly manufactured child safety seats 14.

The Car Seat Alarm System 10 of the present invention is easily installed and activated in a manner of minute. A child is harnessed and buckled into their car seat 14. Upon arrival and parking in an ending destination, the base alarm 20 of the Car Seat Alarm System 10 immediately sounds an alert alarm when the driver turns off the car 12 and exits the car if the driver has not attended to a child in its car seat 14. A forgetful adult is served with a clear reminder that they must return to the vehicle 12 immediately. Durably constructed of high quality materials and components, the Car Seat Alarm System 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A car seat alarm system for alerting a parent or caretaker to retrieve their infant child prior to exiting a vehicle, the vehicle having an openable door mounted within a door frame, the car seat alarm system comprising:
a child car seat having a harness;
a fastener positioned on the harness, the fastener closable to secure the harness around the infant child, the fastener openable to unsecure the harness from around the infant child;
a transmitting system mounted on the child car seat; and
a receiving system associated with the door and the door frame and directly interfacing with the transmitting system;
wherein upon opening the door from within door frame, with the fastener closed to secure the harness around the infant child, the transmitting system provides an alert; and
wherein the alert reminds the parent or caretaker to retrieve the infant child prior to exiting the vehicle.

2. The car seat alarm system of claim 1 wherein the transmitting system is a base alarm installed on a base or a rear of the child car seat.

3. The car seat alarm system of claim 2 wherein the base alarm contains a corresponding sensor and transmitter mechanism and is installed on the fastener of the harness.

4. The car seat alarm system of claim 2 wherein the base alarm of the transmitting system has a substantially square shape.

5. The car seat alarm system of claim 2 wherein the base alarm is releasably secured to the child car seat.

6. The car seat alarm of claim 5 wherein the base alarm is secured to the child car seat by means of corresponding hook and loop fasteners.

7. The car seat alarm of claim 2 wherein the base alarm is automatically engaged and armed wheel the fastener is closed to secure the child with the child car seat.

8. The car seat alarm of claim 1 and further comprising:
an adapter cord connected to any vehicle outlet port to provide necessary and required power to the transmitting system.

9. The car seat alarm of claim 1 wherein the transmitting system is battery operated.

10. The car seat alarm of claim 1 and further comprising:
an activation switch located on the transmitting system for activating and deactivating the transmitting system.

11. The car seat alarm of claim 1 wherein the receiving system is a door contact system associated with the door and the door frame and directly interfacing with the base alarm, the door contact system having a roof mount sensor component mounted to the openable door and a door frame sensor component mounted to the vehicle door frame, the door mount sensor component and the door frame sensor component in magnetic contact with each other when the door is dosed within the door frame.

12. The car seat alarm of claim 1 wherein the receiving system includes a speaker, the alert being an audible alarm transmitted through the speaker.

13. The car seat alarm of claim 1 wherein the alert is a visual alarm capable of being transmitted to a cellular telephone.

14. The car seat alarm system of claim 1 wherein the receiving system utilizes a battery source.

15. A method for alerting a parent or caretaker to retrieve their infant child prior to exiting a vehicle, the vehicle having an openable door mounted within a door frame, the method comprising:
providing a child car seat having a harness;
positioning a fastener on the harness;
closing the fastener to secure the harness around the infant child;
mounting a transmitting system on the child car seat;
associating a receiving system with the door and the door frame;
directly interfacing the receiving system with the transmitting system;
opening the door from within the door frame;
providing an alert reminding the parent or caretaker to retrieve the infant child prior to exiting the vehicle;
opening the fastener to unsecure the harness from around the infant child; and
removing the from the car seat and the vehicle.

16. A car seat a arm system for alerting a parent or caretaker to retrieve their infant child prior to exiting a vehicle, the vehicle having an openable door mounted within a door frame, the car seat alarm system comprising
a child car seat having a harness;
a fastener positioned on the harness, the fastener closable to secure the harness around the infant child, the fastener openable to unsecure the harness from around the infant child,
a base alarm mounted on the child car seat, the base alarm automatically engaged and armed when the fastener is closed to secure the child with the child car seat; and
a door contact system associated with the door and the door frame and directly interfacing with the base alarm, the door contact system having a door mount sensor component mounted to the openable door and door frame sensor component mounted to the vehicle door frame, the door mount sensor component and the door frame sensor component in magnetic contact with each other when the door is closed within the door frame;
wherein upon opening the door from within the door frame and breaking the magnetic contact between the door mount sensor component and the door frame sensor component, with the fastener closed to secure the harness around the infant child, the transmitting system provides an alert; and
wherein the alert reminds the parent or caretaker to retrieve the infant child prior to exiting the vehicle.

17. The car seat alarm system of claim 16 wherein the base alarm contains a corresponding sensor and transmitter mechanism and is installed on the fastener of the harness.

18. The car seat alarm of claim 16 and further comprising:
an activation switch located on the transmitting system for activating and deactivating the transmitting system.

19. The car seat alarm of claim 16 wherein the receiving system includes a speaker, the alert being an audible alarm transmitted through the speaker.

20. The car seat alarm of claim 16 wherein the alert is a visual alarm capable of being transmitted to a cellular telephone.
